(19) United States
(12) Patent Application Publication
(10) Pub. No.: US 2020/0376922 A1
(43) Pub. Date: Dec. 3, 2020

(54) ENERGY EFFICIENT TEMPERATURE REGULATED HEAT EXCHANGER SYSTEM

(71) Applicant: PADMINI VNA MECHATRONICS PVT. LTD., Gurgaon (IN)

(72) Inventors: KABIR BHANDARI, GURGAON (IN); RADU GOGOANA, SAN FRANCISCO, CA (US)

(21) Appl. No.: 15/733,152

(22) PCT Filed: Nov. 29, 2018
(86) PCT No.: PCT/IB2018/059436

§ 371 Date: May 29, 2020

(30) Foreign Application Priority Data
Nov. 29, 2017 (IN) 201711042826

(51) Int. Cl. B60H 1/00; B60N 2/56

(52) U.S. Cl. CPC B60H 1/00285; B60N 2/5628; B60H 2001/00307; F28F 2255/02; B60H 2001/003; B60N 2/5642

(57) ABSTRACT

The present invention provides a method and system for cooling a seat 14 surface, comprising at least one cushion, plurality of flexible metallic heat exchangers and optionally a cushioning layer. The metal heat exchangers are thin flexible metal sheets 18a, 18b with high thermal conductivity and a preferable thickness in the range of 0.05 mm and 10 mm. These are incorporated in the cushion, wherein the conduit is bonded, soldered or brazed to thin flexible metal sheet 18a, 18b acting as continued or intermittent conduit, with fluid, for cooling the metallic heat exchangers. The present system allows lowering of the total temperature difference improving the coefficient of performance of the refrigeration system that supplies the cooled fluid, leading to a smaller, lighter cold water supply system that also consumes less power and performs direct cooling of an occupant's body.

### FIELD OF THE INVENTION

The present invention relates to an energy efficient personalized comfort temperature regulated seat heat exchanger system. More specifically, the invention provides plurality of flexible metallic heat exchangers on a surface, such as a seat, to optimize comfort and cooling, for direct contact cooling or heating while avoiding contact with hard parts of the body to prevent discomfort.

### BACKGROUND OF THE INVENTION

Cooling or heating of an ambient space is wasteful, especially when the occupants are required to be stationary, such as while travelling seated in a car, flight or while sleeping. On automobiles, air conditioning systems are installed to cool an ambient space which draws power directly from combustion based engine or battery powered storage medium. The power drawn by such systems to control the temperature of ambient spaces reduces the total traveling range of these vehicles.

More recently, automobile manufacturers have shifted focus on cooling occupants directly rather than ambient space; seat cooling systems are an example of such efforts to enhance the overall efficiency of the cars. There are two preferred types of seat cooling systems used by the car manufacturers, i.e. ventilated seats and cooled seats. Ventilated seats work by blowing cabin air into chambers and then into the seat. The cooled seats have the air blown through a cooled heat exchangers and then into the seat. Perforations in the seats allow the air to reach the occupant. Both systems use high pressurized blowers to force air through small perforations in the seat.

Apart from these systems, a lesser employed method uses fluid cooling where the seat is cooled by circulating temperature controlled fluid such as water, through flexible plastics or rubber tubes. These flexible plastics or rubber tubes are placed under the seat cover, and then transfer heat to the body. The seat cooling by circulating liquid is not widely used, as they are inefficient as compared to the other two majorly used types due to the low thermal conductivity of the flexible plastics or rubber tubes which greatly limit the amount of cooling that could be imparted to the body. The low thermal conductivity of the tube wall acts as an insulator, and requires a high temperature difference between the heat transfer fluid inside the tube and the skin, in order to transfer heat. For reference, normal body temperature is approximately degrees Celsius, and the water temperature inside a liquid-cooled-garment should typically be provided in a range of 15 to 20 degrees Celsius for the wearer to feel cool. As a result, the water chilling apparatus must be larger, heavier, and more power-consuming to provide colder water in high-ambient-temperature conditions. Improving the heat transfer reduces the need for such cold water, therefore reducing power consumption and making the cold-water-supply apparatus smaller and lighter.

The ideal skin-to-fluid heat exchanger should have high thermal conductivity and flexibility. The polymer tubes typically used in heat exchangers have thermal conductivity ranging from 0.1 to 0.3 watts per meter Kelvin. Research has been done on improving the thermal conductivity of flexible polymers, with the best commercially available thermally conductive polymers achieving thermal conductivities of up to 3 watts per meter Kelvin.

An alternative solution is metals, which have far better thermal conductivity than polymers. For reference, aluminum has a thermal conductivity of 205 W/mK and copper is at 401 W/mK. Copper has over 1,000 times better thermal conductivity than commonly used tubing in heat exchangers, and more than 100 times better conductivity than the current state-of-the-art polymers. There are numerous benefits of having a heat exchanger with better heat transfer coefficient. Most importantly, better heat transfer allows for a lower total temperature difference between the cold-side and the hot-side of the refrigeration system, which leads to improved thermal efficiency of the refrigeration system.

Hence, there is a technological gap wherein a system is required that incorporates metal in heat exchangers for direct cooling of the body, a system that improves the coefficient of performance of the refrigeration system, leading to a smaller, lighter cold water supply system that also consumes less power, which also leads to a lighter energy storage system to run, can be custom built or retro-fitted into existing car seats for cooling, is simple in construction, and does not compromise the comfort of an individual.

### OBJECT OF THE INVENTION

The main object of the invention is to provide a metallic heat exchanger system on a surface such as automotive, office, and home seats for direct cooling of an occupant's body.

Yet another object of the invention is to provide a method for placement of flexible metallic heat exchangers on an occupant surface such as automotive, office, and home seats for direct cooling of an occupant's body, optimizing comfort and cooling, by avoiding contact with hard parts of the body to avoid discomfort.

Yet another object of the invention is to provide a method for placement of flexible metallic heat exchangers on an occupant surface such as automotive, office, and home seats for direct cooling of an occupant's body, optimizing comfort and cooling, by avoiding contact with hard parts of the body with flexible metallic heat exchangers removing heat from the skin by circulating a cooling fluid throughout it.

Yet another object of the invention is to place the flexible metallic heat exchangers on the seat to make them nearly un-detectable to the occupant during normal use.

Yet another object of the invention is to place the flexible metallic heat exchangers on the seat to make them nearly un-detectable and avoid condensation on the flexible metallic heat exchangers so that cooling the portion of the seat that comes in contact with the body at all times while occupying the seat.

Yet another object of the invention is to provide exposed flexible metallic heat exchangers, thereby lowering of the total temperature difference, improving the coefficient of performance of the refrigeration system, leading to a smaller, lighter cold water supply system that also consumes less power, which also leads to a lighter and cheaper energy storage system to run it.

### SUMMARY OF THE INVENTION

Accordingly, in the light of the existing drawbacks, the present invention provides a flexible metallic heat exchanger system on a seating surface for directly cooling an occupant, wherein metallic heat exchangers are installed on any surface such as seats, mattresses etc. for directly cooling of an occupant's body without using air blowers, and can be retro fitted to existing seats or mattresses. The metallic heat exchangers improve the heat transfer from the body to the cooling fluid, reducing the need for unnecessarily cold water, therefore reducing power consumption and making the cold-water-supply apparatus smaller and lighter, making the system more efficient therefore attractive for use in electric vehicles and systems where energy efficiency is critical to system-wide performance.

In an embodiment of the present invention, the invention provides a system and a method of installing heat exchanger system on a surface such as automotive, office, and home seats for direct cooling of an occupant's body. The invention provides flexible metallic heat exchangers wherein flexible metallic heat exchangers are integrated or placed on a surface such as automotive, office or home seats for direct cooling or contact cooling of an occupant's body, thereby obviating the need for a blower or customized seats. The invention optimizes comfort and cooling, by installing or placing flexible metallic heat exchangers, such that when seating upright and lower back in contact with the back portion of the seat, avoids any contact with bonier parts of the body. The flexible metallic heat exchangers regulate heat transfer from the skin by circulating temperature controlled fluid.

In an embodiment of the present invention, the system comprises of a plurality of metal plates or sheets acting as heat exchangers, preferably below the surface of seating surface such as a car seat which is either placed or integrated into a seat cover, connected via thin flexible metal tubes, preferably between 0.5 mm and 10 mm in outer diameter, that are soldered, brazed, bonded, or welded to the thin flexible metal plates or sheet acting as the continued or intermittent conduit or pipes, with fluid, for cooling the metallic heat exchangers. The conduit or pipes are further connected to a fluid cooling system to provide cold fluid for circulation though the conduit. An occupant sitting in the seat shall be cooled as the cold fluid that cools the metal plates are tightly pressed against the area of contact of a human body, thereby exchanging heat.

In yet another embodiment of the present invention, metal heat exchangers applied to a car seat conform to the shape of the body and the heat exchanger remains tightly pressed against the body, by the weight of the person sitting on this surface. The metal heat exchangers are thin flexible metallic sheets with high thermal conductivity and a preferable thickness in the range of 0.05 mm and 10 mm, to be incorporated in the metallic heat exchangers that conform to the shape of the body. The metal conduit is soldered, brazed, bonded, or welded to the thin flexible metal sheet acting as continued or intermittent conduit, with fluid, for cooling or heating the metallic heat exchangers. The present system allows lowering of the total temperature difference, improving the coefficient of performance of the refrigeration system, leading to a smaller, lighter water supply system that also consumes less power, which also leads to a lighter energy storage system to run it.

In yet another embodiment of the present invention, a method of regulating temperature of human body is created by providing heat exchangers on a car seat that conforms to the shape of the body and the heat exchanger remains tightly pressed against the body, by the weight of the person sitting on this surface. The metallic heat exchangers comprise of thin flexible metal sheets with high thermal conductivity and a preferable thickness between 0.05 mm and 10 mm, to be incorporated in the metallic heat exchangers that conform to the shape of the body. The metal conduits are soldered, brazed, bonded, or welded to the thin flexible metal sheet acting as continued or intermittent conduit, with fluid, for cooling or heating the metallic heat exchangers. The heat exchangers are placed on the seat to avoid the inferior pubic ramus bones and the tailbone, therefore, there is only foam underneath the seating surface at this portion for maximum softness and comfort and conversely cool the bottom part of the thighs, with flexible metallic heat exchangers beneath the seat surface. This is the “meaty” portion of the leg, and the occupant never feels the metallic portion underneath the surface thereby making the heat exchangers nearly un-detectable while in a normal, upright seating position.

In yet another embodiment of the present invention, the invention provides a method of cooling or heating human body by providing heat exchangers on a car seat wherein to avoid condensation on the seating surface and only those portions are provided by heat exchangers that comes in contact with the body such as bottom part of the thighs, upper back and lower back, while avoiding any bones that may come in contact.

### BRIEF DESCRIPTION OF THE DRAWINGS

A complete understanding of the method of the present invention may be obtained by reference to the following drawings:

FIG. 1 elucidates the seat temperature regulating system with flexible heat exchangers according to an embodiment of the present invention;

FIG. 2 elucidates the seat temperature regulating system with flexible heat exchangers in a disassembled view according to an embodiment of the present invention;

FIG. 3 elucidates an arrangement of flexible heat exchangers on a seat according to an embodiment of the present invention;

FIGS. 4a and 4b elucidate fluid cooling arrangements in a vehicle according to an exemplary embodiment of the invention;

FIG. 5 elucidates the contact areas of an occupant's body car seat cooling system with flexible heat exchangers according to an embodiment of the present invention;

FIG. 6 elucidates an alternate arrangement of the most preferred embodiment of the seat temperature regulating system with flexible heat exchangers according to an embodiment of the present invention;

FIG. 7 elucidates fluid circulation system for a flexible heat exchangers according to an embodiment of the present invention; and

FIG. 8 elucidates a preferred implementation of fluid circulation system cooling the flexible heat exchangers installed in the seat according to an embodiment of the present invention.

### DETAILED DESCRIPTION OF THE INVENTION

The present invention will now be described more fully. This invention may, however, be embodied in many different forms and should not be construed as being limited to the embodiment set forth herein. Rather, the embodiment is provided so that this disclosure will be thorough, and will fully convey the scope of the invention to those skilled in the art.

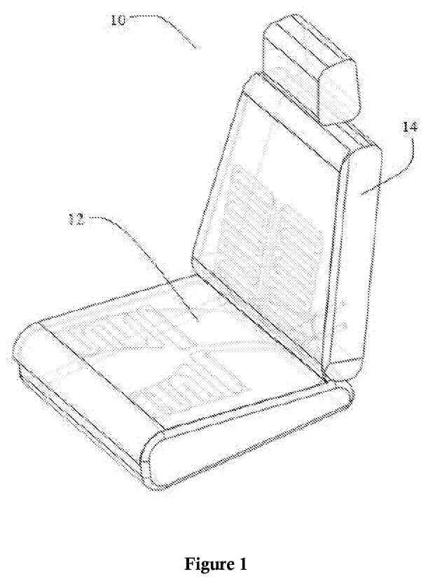

Referring to FIG. 1 elucidates the seat temperature regulating system 10 with flexible heat exchangers, a seat temperature regulating system 10 is shown comprises of a passenger seat 14 and a flexible heat exchanger system 12.

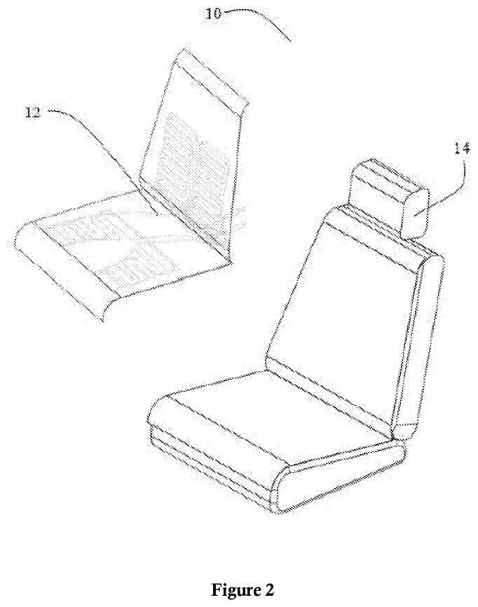

Referring to FIG. 2 elucidates the seat temperature regulating system 10 with flexible heat exchangers in a disassembled view; a seat temperature regulating system 10 is shown in disassembly. The detachable and portable flexible heat exchanger system 12 is detached from the passenger seat 14 as one of the alternate embodiments. Similarly, the detachable and portable flexible heat exchanger system 12 is attachable to all existing models of seat by installing the flexible heat exchanger system 12 on a flexible surface such as cloth, leather or leatherette.

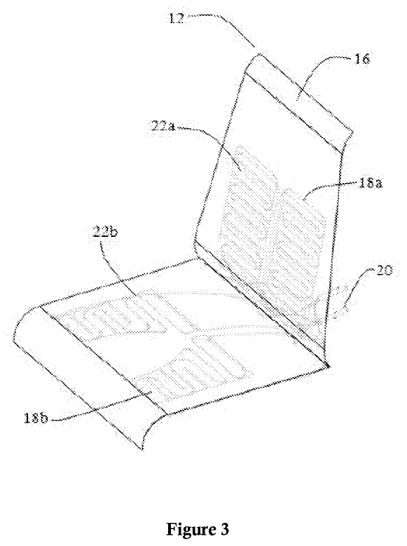

Referring to FIG. 3 elucidates an arrangement of flexible heat exchanger system 12 on a seat 14, the flexible heat exchanger system 12 comprises of a flexible sheet 16 made up of materials like Polyurethane polymers, cloth, leather etc; a plurality of thin metal sheets 18a and 18b, a channel of pipes 22a and 22b. The plurality of thin metal sheets 18a and 18b are temperature regulated by circulating fluid through the flexible channel of pipes 22a and 22b which in turn are connected to a fluid temperature regulating unit through a flexible pipe or hose attachment 20 preferably made of polymer such as polyurethane which is further connected to the condenser unit 30 or HVAC (Heating, Ventilation and Air-Conditioning) system of a vehicle or residential HVAC system 28. Therefore, an energy efficient seat temperature regulating system 10 using a fluid in an environment including but not limited to a car or room comprises of:
at least one detachable and portable flexible heat exchanger system 12;
at least one fluid temperature regulating unit;
a fluid circulation system for circulation of fluid; and
a plurality of pipe and hose attachment 20;
wherein,
said flexible heat exchanger system 12 comprises a plurality of metallic sheets 18a, 18b with at least one channel of pipes 22a, 22b connected underneath and positioned below a flexible sheet 16 acting as a cover;
said flexible heat exchanger system 12 is connected through said pipe and hose attachment 20 to the fluid temperature regulating unit to cool or heat the fluid and to the fluid circulation system to circulate the fluid in the channel of pipes 22a, 22b to cool or heat the metallic sheets 18a, 18b of the flexible heat exchanger system 12 and regulate temperature of a seat 14; and
said channel of pipes 22a, 22b at one end is connected to hose and pipe attachment 20 for input of cooled or heated fluid through the fluid temperature regulating unit in line connection with the fluid circulation system and at other end is connected to hose and pipe attachment 20 for output of fluid in the fluid circulation system.

The fluid temperature regulating unit comprises of at least one water heater 42, at least one evaporator 36 and optionally a fan 46 in connection with an air conditioning unit or HVAC system 28 available in the environment through an expansion valve 34 where the system 10 is in use. The channel of pipes 22a, 22b are metallic and preferably of copper and other conductive materials. The metallic sheets 18a, 18b are preferably made of metal including but not limited to copper and aluminum.

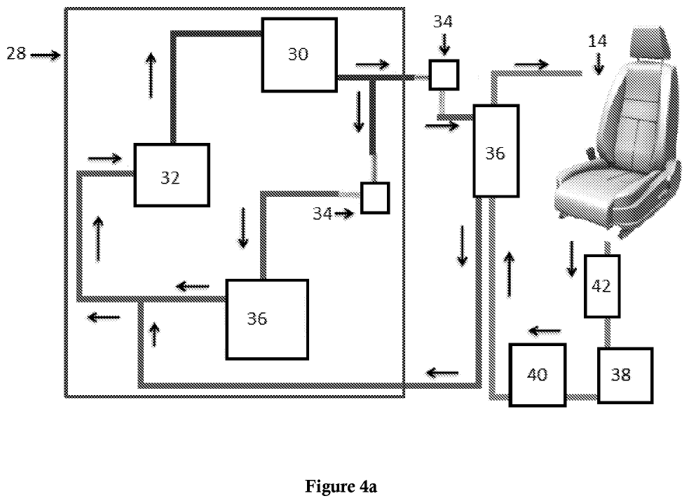

Referring to FIG. 4a in an exemplary embodiment in a vehicle, the fluid temperature regulating unit comprises of a water heater 42, an evaporator 36 and optionally a fan 42. The fluid temperature regulating unit is connected to the condenser unit 30 of suitable HVAC system 28 via an expansion valve 34. The fluid temperature regulating unit is positioned near the evaporator 36 of the HVAC system 28 in the vehicle and placed near the refrigerant lines in the vehicle. The hose and pipe attachment 20 extend to the seats 14 and there are at least 2 hoses per seat.

Referring to FIG. 4b is another exemplary embodiment in a vehicle wherein the fluid temperature regulating unit comprising of a water heater 42, an evaporator 36 and a low speed fan 46 in connection with a vent 44 from the air conditioner of the vehicle for cooling of the fluid.

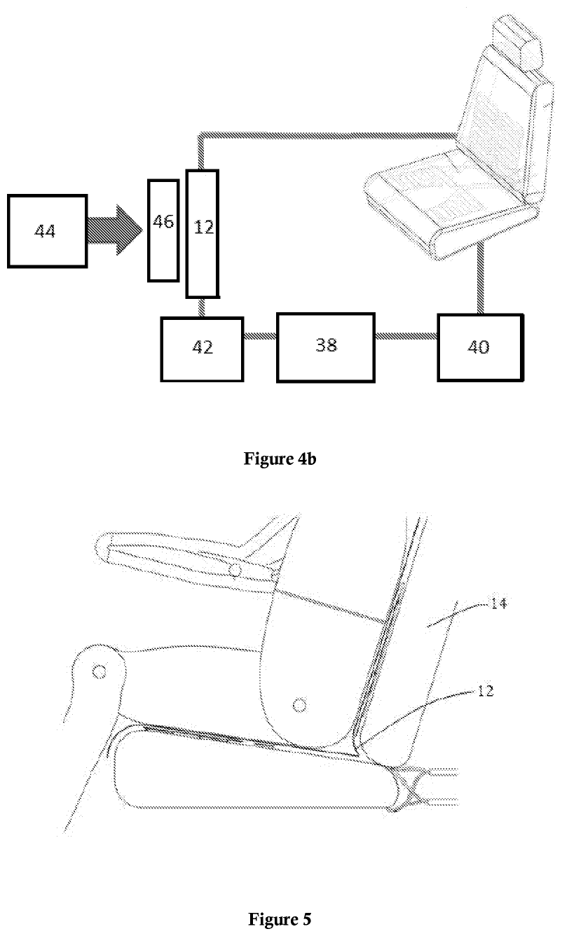

Referring to FIG. 5 elucidates the contact areas of an occupant's body with flexible heat exchanger system 12 of a seat temperature regulating system 10. The seat temperature regulating system 10 is specifically focused around the thighs and lower back, with flexible heat exchanger system 12 on the seat or cover of the seat 14. The heat exchanger system 12 is placed on the seat 14 to avoid the inferior pubic ramus bones and the tailbone, therefore, there is only foam underneath the seating surface at this portion for maximum softness and comfort and conversely cool or heat the bottom part of the thighs, with flexible metallic heat exchanger system 12 beneath the seating surface. This is the fleshy portion of the leg, and the occupant will not feel the metallic portion underneath the surface thereby making the heat exchanger system 12 nearly undetectable.

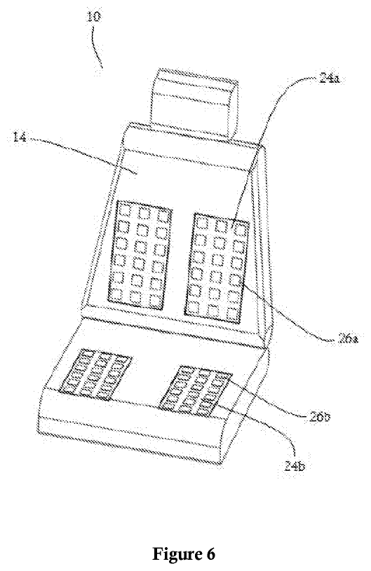

Referring to FIG. 6 elucidates an alternate arrangement of the most preferred embodiment of the seat temperature regulating system 10 with flexible heat exchanger system 12, wherein plurality of briquette shaped heat exchanger 26a are installed on the specific area back support surface 24a and seating surface 24b avoiding inferior pubic ramus bones and the tailbone and engaging fleshy portion of the leg and avoiding the back bone, around the lumbar region.

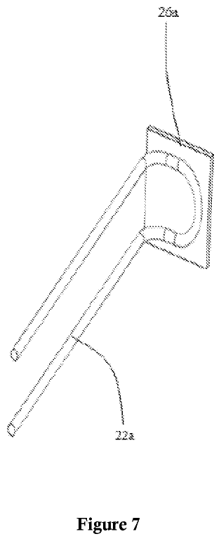

Referring to FIG. 7 elucidates a fluid circulation system for circulating the cooled or heated fluid in the flexible heat exchanger system 12 comprises of a pump 38 and a fluid reservoir 40 for fluid circulation and thin metallic pipes 22a, 22b installed soldered, brazed, bonded, or welded on the metallic sheets or plates that act as the heat exchangers wherein fluid cooled or heated is circulated. The pump 38 used is preferably a pump with a flow rate of 2.5 to 3.5 LPM. The fluid reservoir is of quantity 500-600 ml approximately in case of vehicle containing a fluid preferably water with an industrial coolant such as propylene glycol, ethylene glycol, diethylene glycol, etc. The capacity of fluid reservoir 40 may vary as per the application. The flexible heat exchanger system 26a, 12 is cooled or heated via pipes or conduit 22a, 22b attached to flexible heat exchanger system 26a, 12 which flex under the weight of the person sitting in the seat and also in the back support of the seat, so as to not cause discomfort.

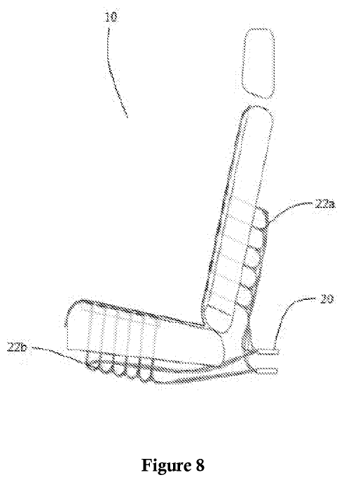

FIG. 8 elucidates a side view of the preferred implementation of fluid circulation system cooling or heating the flexible heat exchangers installed in the seat 14 is shown wherein 22a, 22b are flexible metallic conduits installed on a seat 14 with hose and pipe attachment 20 preferably made of polymer connecting a source of cold water.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. An energy efficient seat temperature regulating system (10) using a fluid in an environment comprising of:
at least one detachable and portable flexible heat exchanger system (12);
at least one fluid temperature regulating unit;
a fluid circulation system for circulation of fluid; and
a plurality of pipe and hose attachment (20);
wherein,
said flexible heat exchanger system (12) comprises a plurality of metallic sheets (18a, 18b) with at least one channel of pipes (22a, 22b) connected underneath and positioned below a flexible sheet (16) acting as a cover;
said flexible heat exchanger system (12) is connected through said pipe and hose attachment (20) to the fluid temperature regulating unit to cool or heat the fluid and to the fluid circulation system to circulate the fluid in the channel of pipes (22a, 22b) to cool or heat the metallic sheets (18a, 18b) of the flexible heat exchanger system (12) and regulate temperature of a seat (14); and
said channel of pipes (22a, 22b) at one end is connected to hose and pipe attachment (20) for input of cooled or heated fluid through the fluid temperature regulating unit in line connection with the fluid circulation system and at other end is connected to hose and pipe attachment (20) for output of fluid in the fluid circulation system.

2. The system (10) as claimed in claim 1, wherein the fluid is water with an industrial coolant preferably propylene glycol.

3. The system (10) as claimed in claim 1, wherein the environment includes but not limited to a car or a room.

4. The system (10) as claimed in claim 1, wherein the fluid temperature regulating unit comprises at least one water heater (42), at least one evaporator (36) and optionally a fan (46) in connection with an air conditioning unit or HVAC system (28) available in the environment through an expansion valve (34) where the system (10) is in use.

5. The system (10) as claimed in claim 1, wherein the fluid circulation system for circulation of fluid comprises at least one fluid reservoir (40) and at least one pump (38).

6. The system (10) as claimed in claim 1, wherein the plurality of metallic sheets (18a, 18b) are thin, flexible and positioned in bottom parts of thighs, upper back and lower back with high thermal conductivity and a thickness in the range of 0.05 mm and 10 mm.

7. The system (10) as claimed in claim 1, wherein the channels of pipes (22a, 22b) are metallic and preferably made of copper and other conductive materials.

8. The system (10) as claimed in claim 1, wherein the channel of pipes (22a, 22b) connected underneath the metallic sheets (18a, 18b) through soldering, brazing, bonding or welding as continued or intermittent conduits.

9. The system (10) as claimed in claim 1, wherein the flexible sheet (16) is preferably made of a material including but not limited to polyurethane polymers, cloth and leather.

10. The system (10) as claimed in claim 1, wherein the metallic sheets (18a, 18b) are preferably made of metal including but not limited to copper and aluminum.
